(19) United States
(12) Patent Application Publication
(10) Pub. No.: US 2008/0062937 A1
(43) Pub. Date: Mar. 13, 2008

(54) Telephonic Device and Service Center-Assisted Network Setup

(76) Inventors: Carl Mansfield, Camas, WA (US); Richard T. Bennett, Livermore, CA (US)

Correspondence Address: MICHAEL BLAINE BROOKS, PC, P.O. BOX 1630, SIMI VALLEY, CA, 93062-1630, US

(21) Appl. No.: 11/530,603

(22) Filed: Sep. 11, 2006

(51) Int. Cl. H04Q 7/24

(52) U.S. Cl. 370/338

(57) ABSTRACT

The embodiments of the present invention provide methods, devices, and systems wherein a network may be configured by using a telephonic relay device to transmit a set of configuration data to one or more nodes to be configured to operably communicate with each other within a network. In other embodiments, a configuration service provider, adapted to receive configuration data requests and transmit configuration data, is also provided.

### FIELD OF THE INVENTION

The embodiments of the invention relate to configuring devices within a network, particularly via telephonic devices.

### BACKGROUND

There is an increasing demand by consumers to network various devices, e.g., computers, entertainment systems, Internet-enabled appliances, and security devices, so as to facilitate easy exchange of information. These devices, however, may conform to various standards, protocols, specifications, and/or security schemes; such that configuring these devices to communicate with each other within a network may involve having a user manually enter cumbersome information. Methods, systems, and devices that facilitate configuring network devices to communicate with each other within a network are thus highly desirable.

### SUMMARY

In one aspect, a method of configuring a network is provided. The method includes the steps of receiving by a telephonic device a set of configuration data for the network, transmitting by the telephonic device the set of configuration data to a node device adapted to be operably coupled to the network, and receiving by the node device the set of configuration data for the network.

In another aspect, a telephonic device is provided. This telephonic device is adapted to configure a network by transmitting a set of configuration data to a node adapted to be operably coupled to the network. The set of configuration data typically includes network connection information. The device includes a user interface, a data store, a telephonic wireless receiver, a node transmitter, and a relay configuration manager. The user interface is adapted to perform at least one of the following: receive input and provide feedback. The data store is adapted to store the set of configuration data. The telephonic wireless receiver, operably coupled to an antenna, is adapted to receive the set of configuration data via a telephonic network. The node transmitter is adapted to transmit the set of configuration data to the node via a node communication channel; while the relay configuration manager module is adapted to retrieve the set of configuration data from the data store and instruct the node transmitter to transmit the configuration data to the node.

In another aspect, a system adapted to configure a local area network is provided. The system includes a telephonic device, a telephonic network, a node communication channel, and a node adapted to be operably coupled to the local area network. The telephonic device, operably connected via the telephonic network, is adapted to configure the local area network by transmitting a set of configuration data to a node adapted to be operably coupled to the local area network. The set of configuration data includes network connection information. The telephonic device includes a user interface, a data store, a telephonic wireless receiver, and a node transmitter. The user interface is adapted to perform at least one of the following: receive input and provide feedback. The data store is adapted to store the set of configuration data. The telephonic wireless receiver, operably coupled to an antenna, is adapted to receive the set of configuration data via the telephonic network. The node transmitter is adapted to transmit the set of configuration data to the node via a node communication channel; while the relay configuration manager module is adapted to retrieve the set of configuration data from the data store and instruct the node transmitter to transmit the configuration data to the node.

### BRIEF DESCRIPTION OF THE DRAWINGS

The present invention is illustrated by way of example and not limitation in the figures of the accompanying drawings, and in which:

FIG. 1 is an exemplary system according to an embodiment of the invention;

FIG. 2 is a high-level flow chart showing an exemplary process of configuring nodes within a network, according to an embodiment of the invention;

FIG. 3 is a high-level block diagram of an exemplary relay device and node devices, according to an embodiment of the invention;

FIG. 4 is an exemplary data flow diagram, showing exemplary information exchanged within a system, according to an embodiment of the invention;

FIG. 5 is a block diagram of an exemplary relay device, particularly a mobile telephonic phone, according to an embodiment of the invention;

FIG. 6 is a block diagram of an exemplary node adapted to be networked, according to an embodiment of the invention; and

FIG. 7 is a block diagram of an exemplary configuration server, according to an embodiment of the invention.

### DETAILED DESCRIPTION

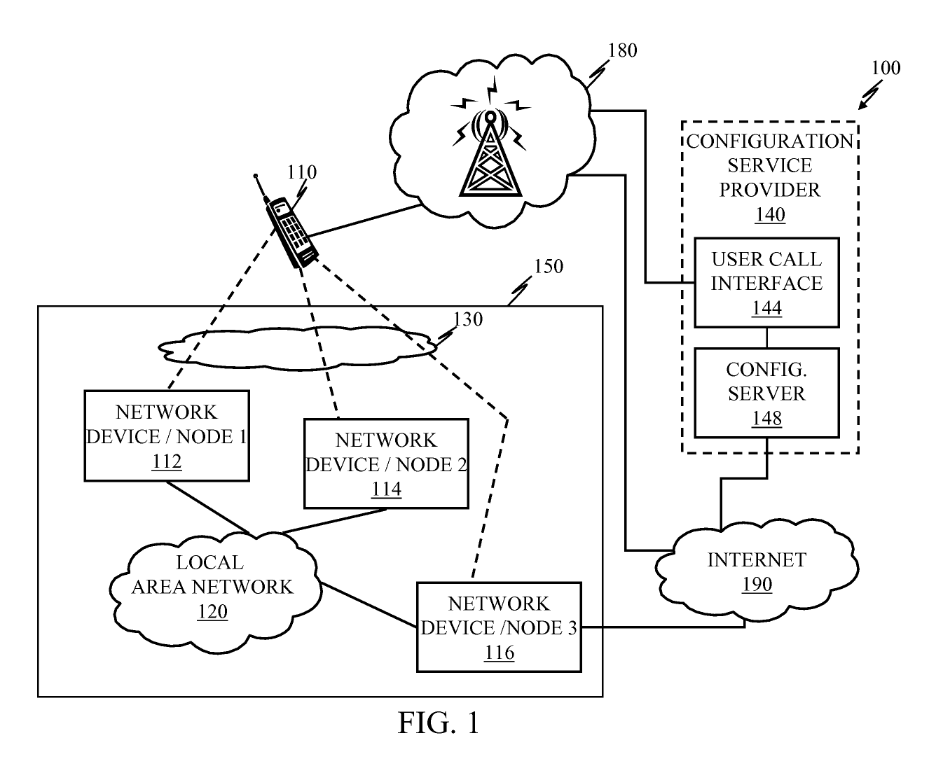

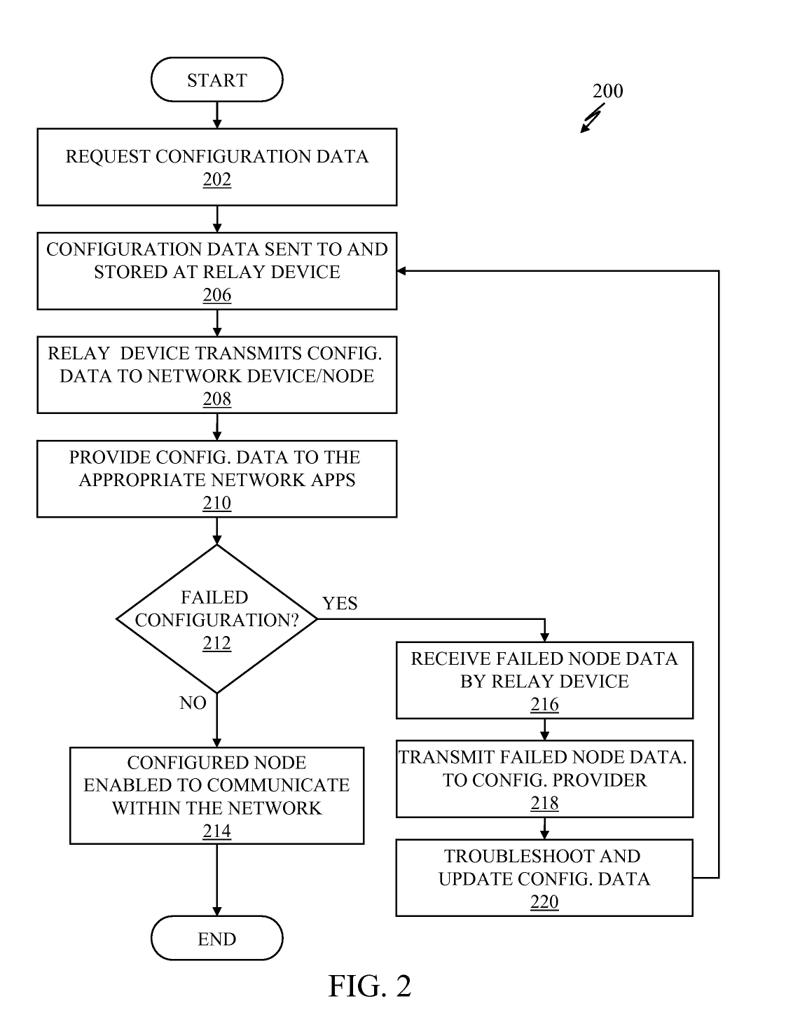

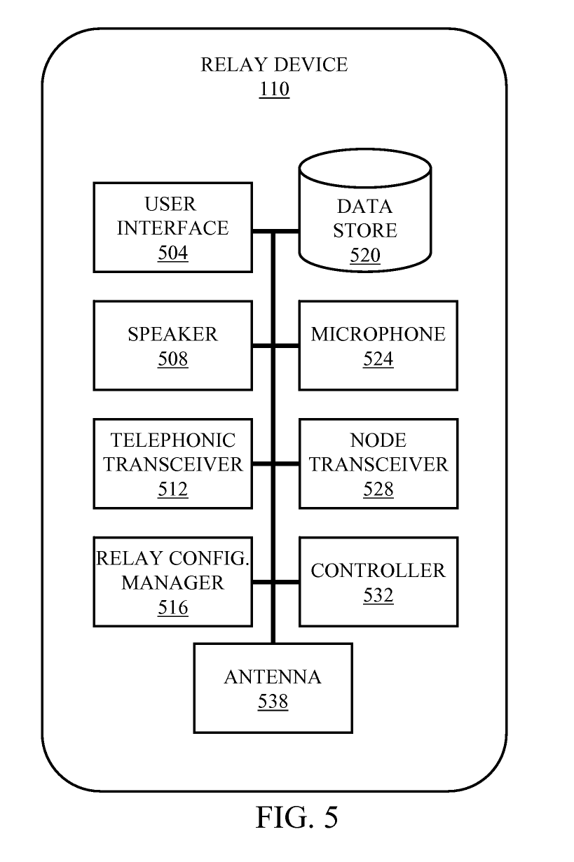

To better understand the figures, reference numerals within the one hundred series, for example, 120 and 150, are initially introduced in FIG. 1, reference numerals in the two hundred series, for example, 202 and 220, are initially introduced in FIG. 2, and so on and so forth. So, reference numerals in the five hundred series, e.g., 504 and 532, are initially introduced in FIG. 5.

The embodiments of the present invention relate to network configuration, particularly to configuration of nodes within a network via the use of a relay device, e.g., a telephonic mobile device. The relay device may be equipped with a wireless interface, e.g., a transceiver, such as an infrared (IR) interface, or a Wireless LAN (Wi-Fi™) interface or a BLUETOOTH™ interface. In some embodiments, the relay device may be equipped with a wired interface, e.g., a universal serial bus (USB). Generally, the telephonic mobile device receives and stores configuration data transmitted by a configuration service provider. The telephonic mobile device may then be used to relay configuration data to one or more nodes so as to enable these nodes to become part of a network and to communicate with each other.

FIG. 1 is a diagram of an exemplary system 100 wherein network configuration via the embodiments of the present invention may be employed. The exemplary system 100 typically includes a relay device 110, a configuration service provider 140, and a configuration environment 150, such as in a home or an office, comprising one or more communication networks, e.g., two or more local area network (LANs) 120. The system 100 may be adapted to support multiple configuration environments 150. The configuration service provider 140 may be a third-party provider that provides configuration data to facilitate configuration of network devices or nodes 112, 114, 116 within a configuration environment 150. Nodes or node devices are typically devices adapted to be part of a network 120, e.g., routers, computers, media players, laptops, set-top boxes, media servers, stereo systems, personal digital assistants, and wireless palm computers.

To provide security within a network 120, each node communicating within the network is typically configured with a set of configuration data/credentials—which may include a password, key, digital certificate, and network identification (ID). This set of configuration data typically prevents unauthorized access to the network 120 by unauthorized or unauthenticated devices, for example. In some embodiments, this set of configuration data provides the necessary credentials for data exchange/network connection(s), e.g., between a networked media server and media player. In some embodiments the configuration data may also be used to prove that the media player has proper rights to access certain stored digital content.

The nodes 112, 114, 116 are operably coupled to each other via one or more network segments 120, which may include wired or wireless network segments or combinations thereof. Such network segments may include Ethernet, power line communication (PLC) networks such as HOMEPLUG™, 802.11a, 802.11g, WI-FI™, and BLUETOOTH™.

The nodes may be part of one or more local area networks (LANs). Furthermore, the system 100 may be adapted to support more than one LAN 120 within a configuration environment 150, e.g., there may be two or more LANs 120 within the home. In some embodiments, each network 120 may have its own set of credentials or configuration data. In other embodiments, the set of credentials may include information relevant only to a particular node device, which is not transmitted to other nodes. Furthermore, each node may receive a different subset of information from the set of configuration data, e.g., depending on the node device and/or network to which the node belongs.

The relay device 110, for illustrative purposes, is a mobile telephonic device operably connected to the configuration service provider 140 via a telephonic network 180, which may include a personal communication services (PCS) network, a mobile cellular network, a satellite mobile network, or combinations thereof. This telephonic network 180, in some embodiments, may include base stations, towers, mobile switching centers, mobile telephone switching offices, short message service centers, paging centers, or variations thereof. This exemplary telephonic network 180 may include what is known as second generation (2G or digital/PCS generation) technology and/or third generation (3G or multimedia cell phones/smartphones) technology. In some embodiments, the telephonic network 180 also interfaces with or includes other networks, e.g., a wide area network (WAN) such as the Internet 190, and other communication network such as the public switched telephone network (PSTN), a circuit-switched network, a packet-switched network, a wired or wireless network, or combinations thereof. Information received and transmitted by the relay device, e.g., the telephonic mobile device, is typically received via this exemplary telephonic network 180. The relay device 110 may also include personal digital assistant (PDA) cell phones, cell phones, smartphones, and other telephonic devices. A smartphone, for example, is an electronic handheld device that integrates the functionality of a mobile phone, personal digital assistant (PDA) or other information appliance.

A user typically may use a mobile telephonic device 110 to call, via a telephonic network 180, the configuration service provider 140. The user's call is typically received at the configuration service provider 140 via a user call interface 144. Depending on implementation, the user call interface 144 may be human and/or non-human. In some embodiments, the call user interface 144 is a service center of the configuration service provider 140, staffed with customer service representatives. In other embodiments, the call user interface 144 consists of one or more computer-automated devices to process user calls. Such computer-automated devices may include programmed voice response units (VRUs), other phone-handling systems, and/or computer systems. The configuration service provider 140 may consist of both human and non-human entities. The configuration service provider 140 transmits the set of configuration data, which is then eventually received by the user's telephonic device 110. The transmission may be made using voiceband modem transmission, Short Message Service (SMS), packet data transmission, circuit switched data transmission, or other means. In some embodiments, a configuration server 148, e.g., a computer-based device or system, is utilized to determine and/or transmit the set of configuration data to the telephonic device 110.

In some embodiments, a properly configured node 112, 114, 116 may directly communicate with the configuration server 148, via wired or wireless network segments or combinations thereof, e.g., via a WAN such as the Internet 190. The telephonic relay device 110, on the other hand, typically communicates with the nodes 112, 114, 116 in the network 120 via a node communication channel 130, which may be wireless or wired. Such node communication channel/network 130 may include, for example, a radio frequency (RF) network or an infrared (IR) network. The embodiments of the present invention thus enable the configuration server 148 to send configuration data to nodes 112, 114, 116, via the relay device 110, even if said nodes are not configured in a manner which enable them to communicate on the local area network 120 or with devices via the Internet 190.

FIG. 2 is a flow chart showing an exemplary process 200 of some embodiments of the invention. In the first operation, a set of configuration data for a network 120 is requested from a configuration provider 140 (step 202). This set of configuration data comprises one or more configuration data fields or parameters. In some embodiments, this step 202 may be performed by having the user call the user call interface 144, e.g., the customer service center of the configuration service provider, requesting that the user's network, including node devices, be configured. The call may be placed by the user using the same relay device 110 to which the set of configuration data is to be transmitted. By using the same relay device 110, the customer service representative, for example, may more easily identify the caller's phone number, via a caller identification (caller-ID) device, thereby facilitating obtaining the phone number to which the set of configuration data is going to be transmitted. In other embodiments, the user may use a plain old telephone system (POTS) via the PSTN. The user during the phone conversation or via user input, e.g., touchpad input, may inform the customer service representative to which phone number the set of configuration data is to be transmitted. In other embodiments, a user may request the set of configuration data via a web site provided by the configuration provider. This web site may be served by a web server residing or separate from the configuration server 148. In this embodiment, the web site may interface with a database, e.g., a relational database management system (RDBMS), containing information of various configuration data fields that a particular node device and/or network may require as part of authentication and security. For example, a node being authenticated and secured within a wireless network 120—wireless network configuration—may require several data fields, including, service set ID or network name (SSID), wired equivalent privacy (WEP) key, and/or channel number. In other embodiments, the set of configuration data may include Internet Protocol information, e.g., subnet mask, default gateway address, preferred domain name system (DNS) server, and alternate DNS server. Configuration data may also include settings on parameter fields, e.g., indicating “WEP” being used versus Wi-Fi Protect Access (WPA) or WPA2, appropriate Boolean values, e.g., indicating dynamic host configuration protocol or not, and other protocol parameters, such as values enabling or disabling ports. Depending on various factors, e.g., the node type, network type, and/or applications running on those nodes, the fields contained in the set of configuration data transmitted to the relay device may vary from node to node being configured and/or from network to network 120. In some embodiments, a node may operate within two or more networks 120. Each network 120 may be provided with its own set of configuration data.

A set of program instructions or application may also be resident in the configuration server 148, which performs the process of determining which configuration data fields may be needed by the particular node and/or network being configured. User-provided information or input may also be requested from the user and incorporated as part of the configuration data. In some embodiments, the web site contains information helpful to a user, for example, suggesting to the user that the network name or SSID be of a certain length or alphanumeric characters.

In other embodiments, the request (step 202) is initiated whenever a user purchases a new network device or node device. At point of sale, the store clerk may initiate this request by filling out a form with configuration data. This form may be a paper form or a form on a web site. The paper form may also be filled-in by the user and mailed to a customer service representative who then enters the configuration data into the configuration server 148. One of ordinary skill in the art will appreciate that there are numerous ways and variations of requesting configuration information.

The configuration request is typically received and responded to by the configuration service provider 140, by transmitting a set of configuration data to the mobile telephonic device 110 (step 206). This configuration data is stored at a data store, e.g., volatile or non-volatile memory, of the telephonic device 110 (step 206). Typically, the telephonic device 110 provides a user feedback indicating that the set of configuration data has been received. For example, a display on the telephonic device 110 may indicate that the configuration data transfer is complete, e.g., via text or an icon.

The set of configuration data is typically sent via the telephonic network 180, e.g., as a short message service (SMS), an email, a page, a text message, via a packet data service, via a circuit switched data connection, or combinations thereof. The set of configuration data, furthermore, may be sent from the service provider side 140 via a telephonic device or a computer. In this exemplary embodiment, an automated system adapted to send text messages to telephonic devices may be employed to transmit the configuration data. In other embodiments, the configuration server 148 may send the set of configuration data to telephonic devices 110 via one or more computers connected to the Internet. This process may be performed, for example, by sending emails over the Internet via a computer. For example, a person wishing to send an email to a TMobile™ user subscriber may do so by sending, over the Internet, an email addressed to the 10-digit phone number and @tmomail.net. For example, if the phone number is (123) 456-7890, an email via an email client application running on a computer may be sent addressed to 1234567890@tmomail.net. That email is then automatically routed and then received by the user's telephonic device 110. Depending on service and/or receiving telephonic device 110, the email may be received as an SMS or email message. In some embodiments, the message is divided into multiple messages. Other cellular phone providers provide similar services. The set of configuration data described herein may also be sent via these exemplary processes.

In other embodiments, if the set of configuration data is sent via email, the user, instead of automatically receiving messages, i.e., data is being pushed to the telephonic device, may request emails sent to its telephonic device by communicating with a Post Office Protocol (POP3) or Internet Message Access Protocol (IMAP) mailbox—i.e., pulls the data. The telephonic device 110 connects, for example, with the Internet via a wireless application protocol (WAP) gateway. The emails are then requested and transmitted to the telephonic device. In some embodiments, an application running in the telephonic device 110 may automatically be triggered to request an email with a particular header information from a specific mail server. This header information indicates that the email contains the set of configuration data requested by the user.

In other embodiments, the set of configuration data is sent via SMS. In this exemplary embodiment, the configuration server 148 transmits the set of configuration data to a specific message center utilizing, for example, a mobile switching center and a messaging center. Once the relay device 110 is alerted that a message is waiting, the telephonic relay device 110 listens for the message containing the set of configuration data and if received properly sends an appropriate received acknowledgement message to the messaging center. Depending on size, the set of configuration data may be divided over several messages due to SMS size limitation. In other embodiments, the set of configuration data may be sent similar to the manner of paging systems, via enhanced messaging service (EMS), or multimedia messaging service (MMS). One of ordinary skill in the art will appreciate that there are various ways of transmitting the set of configuration data to the telephonic device 110.

Once the set of configuration data is received by the cellular device 110, the telephonic device 110 transmits the set of configuration data to the appropriate nodes, via the node communication channel/network 130 (step 208). This transmission may be directed to an unconfigured node so as to enable that node to operably communicate with other nodes in the network, or to an already configured node for update purposes. In some embodiments, an application residing on the telephonic device 110 extracts the data fields from the received set of configuration data, e.g., embodied as an email, and reformats the fields into a proper format for transmission to other nodes. In other embodiments, the set of configuration data is transmitted without further reformatting and/or processing. Applications for telephonic devices may be developed using programming and markup languages, such as Java, C++, Extensible Markup Language (XML), Handheld Device Markup Language (HDML), and Wireless Markup Language (WML). Various other protocols and languages may also be employed.

One of ordinary skill in the art will appreciate that the set of configuration data may be received by the user typically anywhere where telephonic network service is available. Node configuration, however, typically occurs when the telephonic device 110 and the node 112, 114, 116 are in close proximity to each other. For example, the configuration data may be received by the telephonic device 110 while the user is driving on a freeway, but the transmission between the telephonic device 110 and the node occurs when the telephonic device and the node are typically in close proximity with each other.

The transmission between the relay device and the node may be initiated in various ways, e.g., having the user point to the unconfigured node and initiate configuration data transfer/transmission by pressing a button on the keypad of the telephonic device. An application typically retrieves the set of configuration data from the data store and starts transmission via a node transceiver adapted to transmit to and receive data from a node device. One of ordinary skill in the art will appreciate that this transceiver may consist of two separate components, i.e., a receiver and a transmitter. In some embodiments, the set of configuration data is transmitted to a node via a wireless transmitter, e.g., infrared (IR), radio frequency (RF), and microwave. If the telephonic device is equipped with an IR transmitter, the configuration data may be sent and received by the network node via a corresponding IR receiver. Acknowledgments indicating success or failure of the transmission may also be exchanged. In some embodiments, a telephonic device may be equipped with multiple node transceivers, e.g., both IR and RF. A node transceiver is typically adapted to communicate with a node device, whether that node is authenticated in network 120 or not.

In some embodiments, the configuration data transfer/transmission is via an RF transmitter, e.g., conforming to the BLUETOOTH™ or other RF wireless specifications, e.g., IEEE 802.11 and ultra-wideband (UWB). BLUETOOTH™ typically transmits at 2.4 GHz. Each BLUETOOTH™ device typically contains a link controller that performs the function of identifying other BLUETOOTH™ devices, and sending and receiving data. In some embodiments, if the telephonic device 110 and the network node 112 is each equipped with a BLUETOOTH™ interface, the transmission of configuration data may automatically be performed when the two BLUETOOTH™ devices recognize each other. An application running on the relay device 110 and/or the node device 112, 114, 116 may initiate or request that the configuration data be transmitted.

In some embodiments, the telephonic/relay device 110 may be equipped with a wired interface, e.g., parallel interface, serial interface, a universal serial bus (USB) port, or a phone docking station. Configuration data, for example, may be transferred to a node by operably connecting the phone 110 and the node via a USB cable. A set of program instructions/application residing on the telephonic device or on the node may initiate the request or transfer of configuration data.

Once the set of configuration data is received at the node, this set of data is accordingly provided or made available to appropriate network connection modules, e.g., a network connection application or an application programming interface (API) (step 210), thereby configuring the node to be adapted to communicate and join the desired network. In some embodiments, the operation (step 210) may involve updating registries or files. The set of configuration data may also be transmitted to a previously configured node for update purposes, e.g., update new WEP key value or to change the configuration information to enable the node to disassociate with its current network and join and associate with a different network. If the configuration of the node is successful, i.e., the configured node now has the appropriate configuration data and credentials, the node is then enabled to communicate with other nodes associated with the network (step 214). The process of transferring configuration data and node configuration may be repeated for each node that the user wishes to configure or update. Typically, once the set of configuration data is stored in the relay device 110, a user may configure several nodes.

Referring to FIG. 1, for example, let us assume that network device or node 1 112 and node 2 114 are appropriately configured and belong to the same network 120. Node 3 116 is an unconfigured node that has not been authenticated within the network 120. In this exemplary embodiment, once the set of configuration data for this network 120 is received by the telephonic device 110 via the telephonic network 180, the user may use its telephonic cell phone 110 to transfer the set of configuration data received from the configuration provider 140 to Node 3 116. The telephonic device 110 may transfer, for example, the configuration data to Node 3 via an infrared communication channel 130. Node 3 116 then applies or provides the configuration data to its appropriate network connection module(s). Node 3 thus is configured to communicate with the other configured nodes 112, 114 in the network 120. In some embodiments, a keyboard coupled to Node 3 is not necessary, considering that the configuration data may be transmitted via IR. The embodiments of the present invention thus facilitate node configuration of devices which typically do not have keyboards, e.g., media players.

In some embodiments, the set of configuration data may be sent by a preconfigured node device. For example, Node 1 112 may have the appropriate set of configuration data for the network 120 entered manually by the user. An application residing in the configured node may retrieve the entered data and format such data into a set of configuration data. This set of configuration data may be transmitted from the configured node and received by the telephonic device 110 via a wired or wireless communication channel/network 130, similar to those discussed above, e.g., IR, RF, or USB. In this exemplary embodiment, the configured node directly transmits the set of configuration data to the relay device 110. Once the relay device has the set of configuration data, the user may position the telephonic device 110 to be in close proximity with an unconfigured node and accordingly initiate a configuration data transfer. The configured node to some extent functions as a configuration provider. The configured node, assuming it has access to the Internet, may alternatively send a message or email to the telephonic device. The user or an application residing in the configured node may send an email to the telephonic device 110, e.g., as an email or SMS containing configuration data to 1234567890@tmomail.net, as exemplified above. The configuration data may then be stored at the telephonic device 110 for use with configuring other nodes.

In some embodiments, acknowledgments between the telephonic device 110 and the node being configured 112, 114, 116 may be exchanged. If the configuration process, however, fails due to certain conditions (step 212)—e.g., the set of configuration data does not conform to an expected format, data format mismatch, incompatible WEP-key bits, network name not found, and configuration data not transmitted properly—certain operations may be performed to address this situation. In some embodiments, the user may call the customer service center 140 to report the problem. In other embodiments, the user transmits failed node data, e.g., from one of the correctly configured nodes or from the telephonic device. For example, the user may initiate the transfer of failed node data, which may include the set of configuration data used to unsuccessfully configure a node, by pressing a button on the telephonic device 110 or on the node device 112, 114, 116. This button operation, for example, may trigger the telephonic device 110 to transmit a command to the node, triggering the failed node to respond by transmitting failed node data to the telephonic device 110 (step 216). This failed node data transmission may be performed via a wired or wireless means, e.g., IR, RF, or USB. The failed node data are typically stored the data store.

The telephonic device 110 then transmits the failed node data, including other appropriate data, via the telephonic network 180, e.g., as an SMS, email, packet-switched data, text, or circuit-switched data. Once the configuration provider 140 receives the failed node data, e.g., at the configuration server 148, troubleshooting may be performed (step 220). After troubleshooting, the configuration service provider may then transmit to the telephonic device 110 an updated set of configuration data to accordingly configure the nodes in the network (step 220, 206). Alternatively, the failed node data stored in the telephonic device—transmitted by the failed node to the telephonic device—may be transmitted, e.g., via IR, to a properly configured node with access to the Internet, e.g., via IR. The configured node then transmits the failed node data, via the Internet 190, to the configuration server 148.

In some embodiments, sending information—aside from failed node data—from the user to the service provider may be helpful. This information may be passed to the service provider via its customer service representative or via an automated service or non-human entity. This may be beneficial, for example, when an existing user network configuration is not known by the service provider and/or certain configuration data may be needed to be incorporated within the set of configuration data. This transmission of information may be performed similar to the manner where failed node data are transmitted to the configuration provider 140, 148. For example, a preconfigured node transmits, via BLUETOOTH™, information to the telephonic device 110, which in turn transmits such information to the configuration service 140, 148, e.g., using SMS or email. In other embodiments, web server commands, e.g., POST, or other data transmission mechanisms and protocols, e.g., file transfer protocol (FTP) or hyper text transfer protocol (HTTP) may be utilized.

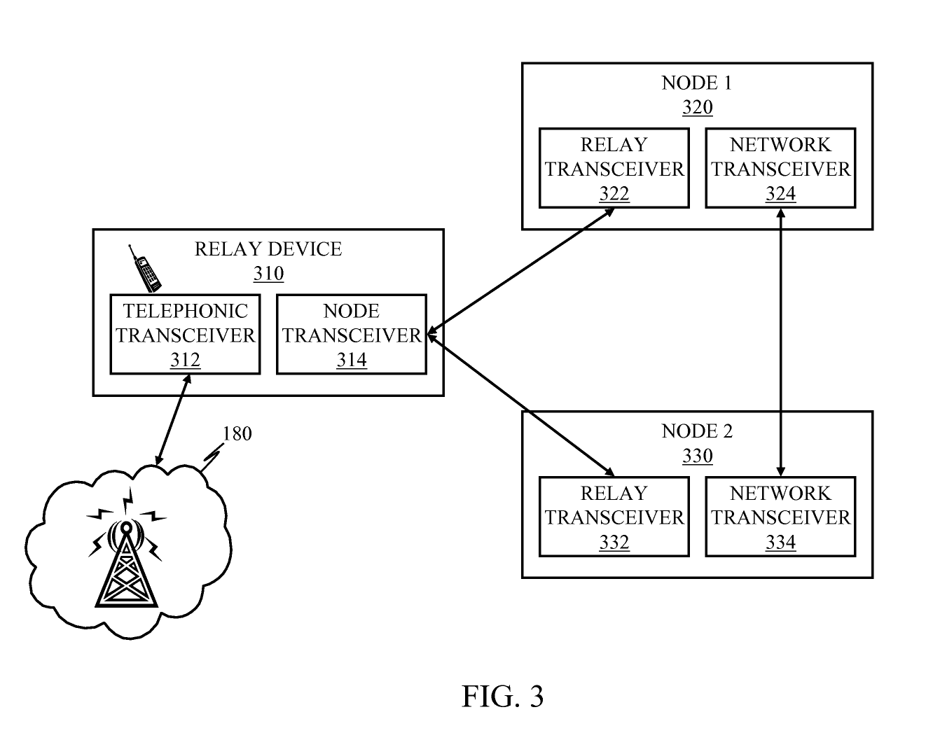

FIG. 3 is an exemplary block diagram showing the exemplary devices of the system 100. A relay device 310, 110 of the present invention typically includes a telephonic transceiver 312 adapted to communicate and interface with a telephonic network 180. This telephonic transceiver 312 enables the relay device 310, 110 to receive phone and data services, including PCS services. The set of configuration data transmitted by the configuration provider is received via the telephonic transceiver 312, typically via a telephonic network. The node transceiver 314, on the other hand, is adapted to transmit to and receive data from the relay transceiver 322, 332 of a node device 320, 330, via a wired or wireless communication channel or communication network, e.g., IR, RF, and USB. Similarly, the relay transceiver 322, 332 is adapted to transmit to and receive data from the node transceiver 314 of the relay device 110, via a wired or wireless communication channel/network. The node transceiver 314 and the relay transceiver 322, 332 are typically compatible with each other, for example, if the node transceiver is IR, the corresponding relay transceiver is also IR and, in some embodiments, may conform to a particular IR standard, for example, IRSimple. The network transceiver or network interface 324, 334 is adapted to transmit and receive data between the nodes within the network 120. For example, the relay transceiver and the node transceiver are adapted to support transmission via IR, while the network transceiver/interface is adapted to support wired network interface, e.g., Ethernet. In some embodiments, the network transceiver/interface 324, 334 is a network interface card.

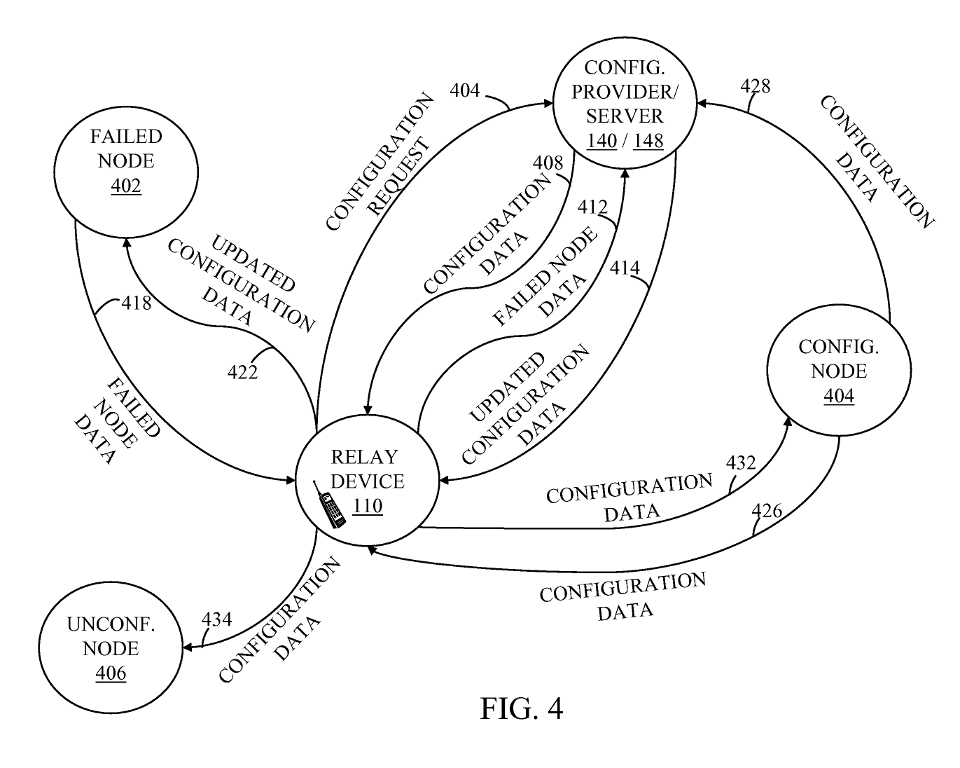

FIG. 4 is an exemplary data flow diagram of some embodiments of the invention. In general, a configuration provider 140, which may include a configuration server 148, transmits configuration data 408 and updated configuration data 414 via a telephonic network 180 to a relay device 110. A relay device 110, on the other hand, may transmit a configuration request 404 and failed node data 412 to the configuration server 148. Failed node data 418 may be received by the relay device 110 from a failed node 402. The relay device may also transmit updated configuration data 422 to a failed node to configure the failed node 402. A relay device 110 also transmits configuration data 434, 432 to an unconfigured node 406 and to a configured node 404. A configured node 404 may also send configuration data 428 to a configuration server 148, 140.

FIG. 5 is a block diagram of an exemplary relay device 110, particularly of a telephonic device, according to some embodiments of the invention. The relay device 110 typically includes a user interface 504, a data store 520, a speaker 508, a microphone 524, an antenna 538, a telephonic transceiver 512, a node transceiver 528, a relay configuration manager 516, and a controller 532. The user interface 504 may include a display adapted to display information, e.g., phone numbers called, error condition codes, and alert messages indicating successful or unsuccessful transmission of configuration data, and an input interface, e.g., a touch pad or a mini keyboard. The user interface may also include a voice-activated and/or voice-command interface, which may be operably coupled to the speaker 508 and/or microphone 524. The speaker 508, the microphone 524, and the antenna 538 are adapted to enable the user to receive and transmit sounds, e.g., conversations, via the telephonic device 110, i.e., to use the device 110 as a telephone. The data store 520 may include volatile and non-volatile memory, adapted to store data e.g., configuration data, phone book information, received SMS messages, applications, and/or operating systems. The telephonic transceiver 512 is adapted to receive and transmit telephonic information so as to enable a user to use the relay device 110 as a phone, as well as to receive and transmit data via the telephonic network 180. The node transceiver 528 is adapted to receive and transmit information between the node transceiver 528 of a relay device and the relay transceiver of a node device. Depending on the capabilities of the relay device, additional modules may be added, e.g., a touch-screen application module, voice command module, stylus module, and calendar module.

The relay configuration manager 516 is adapted to control the transmission and reception of configuration data, failed node data, and other data that may be needed to be exchanged within the various devices or entities within the system 100. The relay configuration manager 516 is also typically adapted to process the set of configuration data, e.g., extract or format the set of configuration data, if appropriate, as well as perform the operations to appropriately configure nodes. The relay configuration manager 516 typically also retrieves the set of configuration data from the data store 520 and instructs the node transceiver 528 to transmit the retrieved set of configuration data.

The controller 532 typically controls and coordinates the overall functions of the relay device 110, e.g., sending instruction to the speaker to make a sound if a call is being received, command and control signaling with cellular base stations, coordinating the user interface, e.g., keyboard and display, and other telephonic-related and device-related functions. The relay device 110 functioning as a cellular phone may, for example, also include an electronic serial number (ESN), a mobile identification number (MIN), and/or a system identification code (SID). An ESN is typically a unique number programmed into the phone when the phone is manufactured. A MIN is typically associated with the cellular phone number. The SID is typically a unique number assigned to each carrier by the FCC. In some embodiments of the invention, the different modules 504, 508, 512, 516, 520, 524, 528, 532, 538, all or portions thereof, may communicate and interface with each other via a bus or dedicated signal paths.

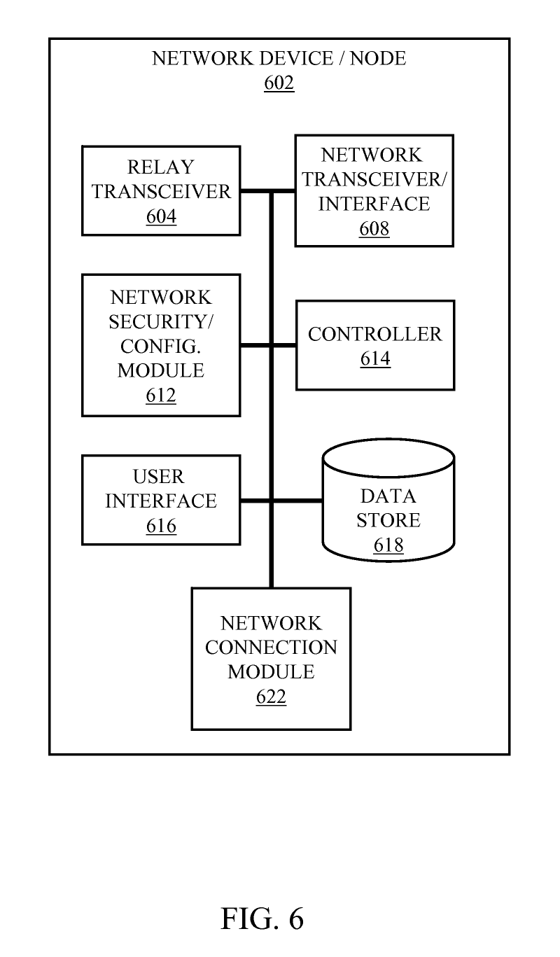

FIG. 6 is a block diagram of an exemplary node device 602, 112, 114, 116 that may be networked into the exemplary network 120 embodiment of the present invention. The exemplary node may include a relay transceiver 604, a network security and configuration module 612, a user interface 616, a network transceiver/interface 608, a controller 614, a network connection module 622, and a data store 618. The relay transceiver 604 is typically adapted to communicate with the node transceiver 528 of the relay device 110. An antenna, not shown, may also be included, e.g., RF antenna or IR detector. The controller 614 is typically adapted to control the overall functions of the node device 602, e.g., if the device is a computer, control the overall functions of the various modules of the computer. A network security and configuration module 612 is typically adapted to control the exchange of configuration data with the relay device and/or the configuration server 148, as well as the various configuration operations and features described herein, so as to enable the node to be configured by the relay device, including receiving the set of configuration data from the relay device. This network security/configuration module 612 may also provide information and/or interface with the network connection module(s) 622, so as to enable appropriate network connection modules in the node, to have the appropriate credentials in the network. The network connection module 622, in some embodiments, is the “Network Connections” application in the Control Panel of a MICROSOFT™ WINDOWS operating system software. The network security and configuration module 612 thus may interface with the network connection module 622 so that the network connection module is able to access the appropriate configuration data so as to configure the node device to be operably connected to and able to communicate and operate within the network 120.

The data store 618 is typically for data storage, e.g., of applications, operating systems, data configuration, and error codes. The user interface 616 module, e.g., a display and a speaker, is adapted to provide mechanisms for a user to interface with the node device. The user interface module 616 may depend on the type of device, e.g., keyboard, mouse, and a display if the node 602 is a computer. Depending on the functions of the node, other modules may be added, modified, and/or removed. For example, if the node is a media player, a module adapted to render movies, e.g., is included as part of the node. The network transceiver/interface 608 is adapted to enable the node to communicate with the other nodes within the network. In some embodiments, the different modules 604, 608, 612, 614, 616, 618, 622 all or portions thereof, may communicate and interface with each other via a bus or dedicated signal paths.

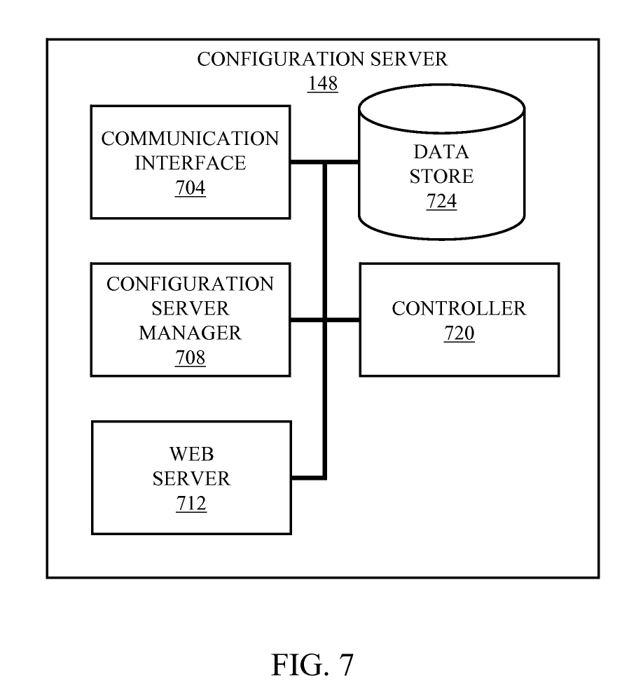

FIG. 7 is a block diagram of an exemplary configuration server 148 that may be deployed in the exemplary system embodiment 100 of the present invention. The configuration server 148 includes a communication interface 704 adapted to enable the server 148 to communicate with the Internet and/or the telephonic network of the present invention. The communication interface 704 may also be a transceiver and may be divided into multiple components, e.g., one component adapted to communicate via the Internet and another component adapted to communicate via the telephonic network 180. In some embodiments, the communication interface 704 is adapted to communicate only with the Internet 190. The configuration server manager module 708, typically interfacing with the communication interface 704, is adapted to control the reception, transmission, and processing of configuration data, including failed node data, as discussed herein. In some embodiments, the configuration server manager 708 determines the set of configuration data to be transmitted. The data store 724 may contain user information, e.g., cell phone number, configuration data, diagnostic data, and other data to implement the features of the present invention. In some embodiments, the configuration server 148 may include a web server 712 dynamically serving web pages, e.g., to enable a user to transmit or upload existing configuration data, comments, and customer service requests. The controller 720 is adapted to control the overall functions and operations of the configuration server 148. The various modules in FIGS. 6, 7, 8 may be implemented in software, hardware, or both.

Although this invention has been disclosed in the context of certain embodiments and examples, it will be understood by those of ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

We claim:

1. A method of configuring a network, the method comprising the steps of:
receiving by a telephonic device a set of configuration data for the network;
transmitting by the telephonic device the set of configuration data to a node device adapted to be operably coupled to the network; and
receiving by the node device the set of configuration data for the network.

2. The method of claim 1, wherein the step of receiving the set of configuration data is via a telephonic network.

3. The method of claim 1, further comprising the step of:
configuring the node device by applying the received set of configuration data, wherein the step of configuring the node device is adapted to enable the node device to operably operate within the network.

4. The method of claim 1, wherein the telephonic network interfaces with at least one other communication network, wherein the at least one other communication network is selected from at least one of the following: Internet; and the public switched telephone network.

5. The method of claim 1, wherein the step of receiving the set of configuration data is via at least one of the following:
via a wireless communication channel; and
via a wired communication channel.

6. The method of claim 1, wherein the step of receiving the set of configuration data comprises receiving the set of configuration data as one of the following:
at least one email;
at least one short message service (SMS) message;
at least one page message;
at least one enhanced messaging service (EMS) message; and
at least one multimedia messaging service (MMS) message.

7. The method of claim 1, wherein the telephonic device is a mobile cellular phone.

8. The method of claim 1, wherein the step of transmitting to the node device is via a wireless communication channel.

9. The method of claim 7, wherein the wireless communication channel is selected from at least one of the following:
infrared (IR); and
radio frequency (RF).

10. The method of claim 1, wherein the step of transmitting is via a wired communication channel.

11. The method of claim 1, further comprising the step of:
transmitting failed node data.

12. The method of claim 1, further comprising the step of:
interfacing with one or more network connection modules of the node device.

13. The method of claim 12, further comprising the step of:
configuring at least one of the network connection modules of the one or more network connection modules of the node device by applying the received set of configuration data, wherein the step of configuring the at least one of the network connection modules is adapted to enable the node device to operably operate within the network.

14. The method of claim 1, further comprising the step of:
transmitting by a configuration server adapted to transmit, via a telephonic network interfacing with a wide area network, the set of configuration data.

15. The method of claim 1, further comprising the step of:
requesting the set of configuration data from a configuration service provider.

16. A telephonic device adapted to configure a network by transmitting a set of configuration data to a node adapted to be operably coupled to the network, wherein the set of configuration data comprises network connection information, the device comprising:
a user interface adapted to perform at least one of the following:
receive input; and
provide feedback;
a data store adapted to store the set of configuration data;
a telephonic wireless receiver, operably coupled to an antenna, adapted to receive the set of configuration data via a telephonic network;
a node transmitter adapted to transmit the set of configuration data to the node via a node communication channel; and
a relay configuration manager module adapted to retrieve the set of configuration data from the data store and instruct the node transmitter to transmit the configuration data to the node.

17. The telephonic device of claim 16, further comprising:
a speaker and a microphone adapted to enable the telephonic device to be used as a phone.

18. The telephonic device of claim 16, wherein the node transceiver is selected from at least one of the following:
a wireless transceiver; and
a wired transceiver.

19. The telephonic device of claim 18,
wherein the wireless transceiver is adapted to support BLUETOOTH™; and
wherein the relay configuration manager module is further adapted to retrieve the set of configuration data from the data store and instruct the node transceiver to transmit the configuration data when the wireless transceiver detects that the node is BLUETOOTH™-enabled.

20. A system adapted to configure a local area network, the system comprising:
a telephonic device operably connected via a telephonic network, the telephonic device adapted to configure the local area network by transmitting a set of configuration data to a node adapted to be operably coupled to the local area network, wherein the set of configuration data comprises network connection information, the telephonic device comprising;
a user interface adapted to perform at least one of the following:
receive input; and
provide feedback;
a data store adapted to store the set of configuration data;
a telephonic wireless receiver, operably coupled to an antenna, adapted to receive the set of configuration data via the telephonic network;
a node transmitter adapted to transmit the set of configuration data to the node via a node communication channel; and
a relay configuration manager module adapted to retrieve the set of configuration data from the data store and instruct the node transmitter to transmit the configuration data to the node;
the telephonic network;
the node communication channel; and
the node adapted to be operably coupled to the local area network.

21. The system of claim 20, wherein the node communication channel is at least one of the following: a wireless channel and a wired channel.

22. The system of claim 20, wherein the telephonic network interfaces with a wide area network comprising Internet.
